(19) United States
(12) Patent Application Publication
(10) Pub. No.: US 2003/0107460 A1
(43) Pub. Date: Jun. 12, 2003

(54) Low voltage MEM switch

(76) Inventor: Guanghua Huang, Prior Lake, MN (US)

Correspondence Address: MERCHANT & GOULD PC, P.O. BOX 2903, MINNEAPOLIS, MN, 55402-0903, US

(21) Appl. No.: 10/014,987

(22) Filed: Dec. 10, 2001

(51) Int. Cl. H01H 51/22

(52) U.S. Cl. 335/78

(57) ABSTRACT

A low-voltage wide band micro electrical mechanical (MEM) switch. The low-voltage MEM switch comprises a contact bridge. A microstrip has an impedance of about 50 Ohms, first and second portions, and a gap defined between the first and second portions. A cantilever arm supports the contact bridge. The cantilever arm has an end portion, an open state, and a closed state. The contact bridge is spaced from the microstrip at a distance of about 12 μm or greater when the cantilever arm is in the open state. The contact bridge provides electrical communication between the first and second portions of the microstrip when the cantilever arm is in the closed state. An electrically conductive coil opposes the first end, wherein the electrically conductive coil moves the cantilever arm from the open state to the closed state when a voltage of about 5 Volts or less are applied across the electrically conductive coil. A housing encloses the cantilever arm, microstrip, and electrically conductive coil. The housing has a height of about 5 mm or less, and the housing is not necessary hermetically sealed.

### TECHNICAL FIELD

The present invention relates to integrated micro electrical mechanical switches, and more particularly, to a micro electrical mechanical switch requiring a low voltage signal to actuate.

### BACKGROUND

As electronic devices become smaller and more powerful, researchers have spent a great amount of time and resources developing and downsizing electrical components that control these devices. Components that have seen a great reduction in size over the years include discrete electrical components such as transistors, integrated circuits, memory devices, batteries, and switches.

One type of switch that has been developed is the micro electrical mechanical (MEM) switch, which has a several functional uses such as opening and closing a circuit, controlling a power supply, and even switching high frequency signals between fiber optic pathways. In order to operate, typical MEM switches utilize two capacitive plates that hold a high voltage charge. Altering the capacitance causes the switch to change between states.

This design has several fundamental shortcomings. For example, it requires the MEM switch to hold a relatively high voltage such as 20 Volts at all time, regardless of whether the switch is actuated. It is very difficult and is not economical to provide a 20 Volt power supply for battery-operated devices such as cell phones and mobile GPS receivers. Another significant example is that the air gap or separation between the capacitive plates must be very small—as small as 5 micrometers. Any type of contamination, whether dust particles or moisture will adversely affect operation of the MEM switch. As a result, MEM switches are typically hermetically sealed, which increases concerns regarding reliability, quality control issues during manufacturing, and cost. The current design of MEM switches also has performance issues. Additionally, MEM devices are typically made on semiconductor material, which requires a fabrication foundry and again increases cost.

### SUMMARY

In general terms, the present invention relates to a low voltage micro electrical mechanical (MEM) switch. A coil is used to actuate the MEM switch in place of capacitive plates. This switch has several advantages over the prior art. For example, a greater gap can be used between contact points for the switch. As a result, the package and related sealing requirements are not as strict. Manufacturing tolerances also are not as strict. Additionally, the switch can be formed on non-semiconductor material and thus neither dies nor a fabrication foundry is required for manufacturing. These advantages reduce the manufacturing cost, increase quality control, and increase product reliability.

Other advantages relate to performance characteristics of MEM switches. For example, a coil requires a relatively low DC voltage signal to actuate the switch when compared to a switch using capacitive plates. It also consumes a relatively small amount of power. Additionally, the insertion loss and return loss of the switch using a coil is also reduced for a broad range of frequencies, including millimeter-wave frequencies. Yet another advantage is the size of a MEM switch embodying the present invention. It can have a small form factor, which allows it to be used with a variety of applications such as minturized devices and devices that have require small packaging requirements.

One aspect of the present invention is directed to a low-voltage MEM switch. The low-voltage MEM comprises a cantilever arm having first and second ends. A contact bridge is connected to the cantilever arm and positioned between the first and second ends. First and second microstrips are electrically isolated from one another. An electrically conductive coil opposes the first end, wherein the electrically conductive coil moves the cantilever arm between an open state and a closed state. The contact bridge provides electrical communication between the first and second microstrips when in the closed state.

Another aspect of the invention is a low-voltage MEM switch. The low-voltage MEM switch comprises a contact bridge. First and second microstrips, each have an impedance of about 50 Ohms and first and second end portions. The first microstrip is electrically isolated from the second microstrip. A cantilever arm supports the contact bridge. The cantilever arm has an end portion, an open state, and a closed state. The contact bridge is spaced from the microstrip at a distance of about 12 μm or greater when the cantilever arm is in the open state. The contact bridge provides electrical communication between the first and second microstrips when the cantilever arm is in the closed state. An electrically conductive coil opposes the first end, wherein the electrically conductive coil moves the cantilever arm from the open state to the closed state when a voltage in the range of about 1 Volt to about 5 Volts is applied across the electrically conductive coil. A housing encloses the cantilever arm, first and second microstrips, and electrically conductive coil. The housing has a height of about 4 mm or less and is not hermetically sealed.

Another aspect of the present invention is a method of closing a circuit using a low-voltage MEM switch. The method comprises providing a low voltage MEM, the low voltage MEM including a cantilever arm, a contact bridge connected to the cantilever arm, an electrical path having first and second portions, and an electrical coil; applying a voltage of about 5 Volts or less across the electrical coil; and in response to applying the voltage of about 5 Volts or less across the electrical coil, moving the cantilever arm from a first position wherein the contact bridge is not in electrical contact with both the first and second portions of the electrical path to a second position wherein the contact bridge is in electrical contact with both the first and second portions of the electrical path.

Yet another aspect of the invention is a method of closing a circuit using a low-voltage MEM switch. The method comprises providing a low voltage MEM, the low voltage MEM including a cantilever arm having first and second ends, a contact bridge connected to the cantilever arm and positioned between the first and second ends, an electrical path having first and second portions, and an electrical coil within a housing having a height of about 4 mm or less; applying a voltage of about 5 Volts or less across the electrical coil; in response to applying the voltage of about 5 Volts or less across the electrical coil, pivoting the cantilever arm around the first end, thereby moving the contact bridge a distance in the range of about 12 μm and about 2 mm from a first position wherein the contact bridge forms an open circuit between the first and second portions of the electrical path to a second position wherein the contact bridge forms a closed circuit between the first and second portions of the electrical path; and conducting an electrical signal along the first portion of the electrical path, through the contact bridge, and then along the second portion of the electrical path, the electrical signal having a frequency that is about 30 GHz or higher.

### DESCRIPTION OF THE DRAWINGS

FIG. 1 is a top plan view of a MEM switch embodying the present invention, the illustrated MEM switch being in an open states, the figure having a breakout showing the details of the MEM switch underneath a lid.

FIG. 2 is a side cross-sectional view of the MEM switch illustrated in FIG. 1, taken along line 2-2.

FIG. 3 is a bottom plan view of the MEM switch illustrated in FIG. 1.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention. There are alternative embodiments for all of the structures and methods disclosed herein regardless of whether specific alternatives are set forth.

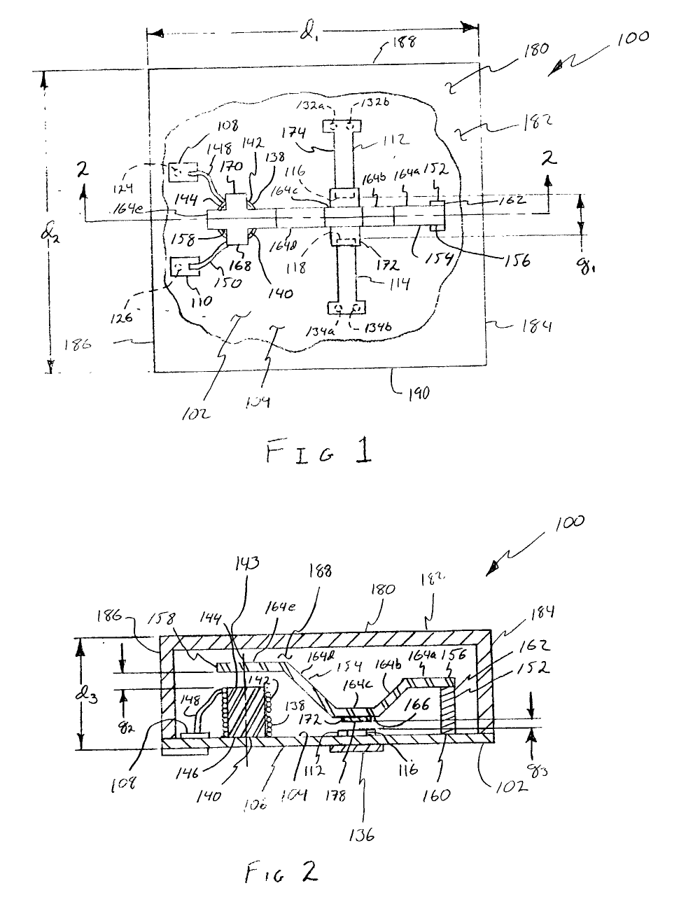

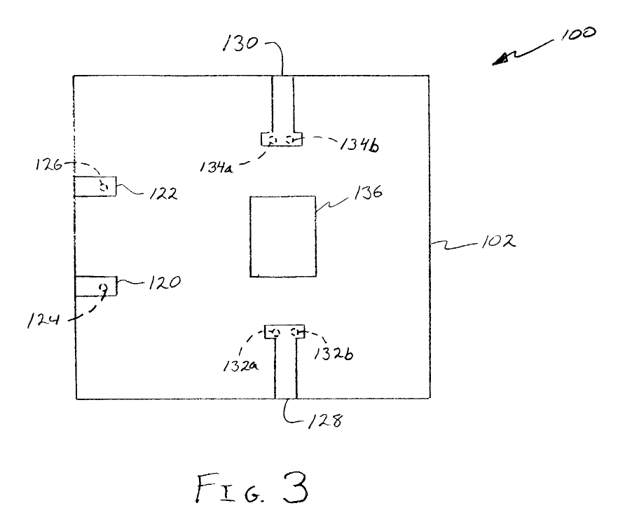

Referring to FIGS. 1 and 2, one possible embodiment of a low voltage micro electrical mechanical (MEM) switch, which is also called a micro electrical mechanical system, is generally illustrated as 100. The MEM switch 100 has a substrate 102 that is made from a material on which electrical traces and components can be mounted. In one possible embodiment, the material used to form the substrate 102 is non-semiconductor material and is otherwise substantially resistant to the flow of electricity. Examples include both organic and inorganic materials such as laminates, ceramic, and PTFE (e.g., Teflon®) materials. Additionally, one possible laminate is Laminate RO4003, which is commercially available from Rogers Corporation of USA.

The substrate 102 has upper and lower surfaces 104 and 106, respectively. First and second bias ports 108 and 110, respectively, are mounted on the upper surface 104 and are formed with an electrically conductive material upon which wires can be soldered or otherwise bonded. First and second contact traces 112 and 114, respectively, also are formed with electrically conductive material and are mounted on the upper surface 104 of the substrate 102. The first contact trace 112 forms a first portion of a signal or electrical path and has a first contact end 116. The second contact trace 114 forms a second portion of a signal or electrical path and has a second contact end 118. The first and second contact ends 116 and 118 are separated by a gap g₁, which in one possible embodiment, is in the range of about 10 μm and about 8 mm. Other embodiments will have the first and second contact ends 116 and 118 (illustrated in phantom lines in FIG. 1) separated by other distances. In one possible embodiment, the first and second contact traces 112 and 114 are formed by microstrips having an impedance of 50 Ohms. Examples of materials that can be used to form the first and second bias ports 108 and 110, and the first and second contact traces 112 and 114 include copper, gold, silver, and other electrically conductive material.

Referring to FIG. 3, a first and second lower traces 120 and 122, respectively, are mounted on the lower surface 106 of the substrate 102. The first lower trace 120 is electrically connected to the first bias port 108 by a first via 124, and the second lower trace 122 is electrically connected to the second bias port 110 by a second via 126. Third and fourth lower traces 128 and 130, respectively, also are mounted on the lower surface 106 of the substrate 104. The third lower trace 128 is electrically connected to the first contact trace 112 by a third and fourth vias 132a and 132b, and the fourth lower trace 130 is electrically connected to the second contact trace 114 by a fifth and sixth vias 134a and 134b.

In order to reduce insertion loss and return loss, the impedance of the vias 132a, 132b, 134a, and 134b can be controlled by adjusting the distance between them and their proximity to a ground plane or other grounded structure. An example of such a controlled impedance structure is illustrated in U.S. Pat. No. 6,294,966, the disclosure of which is hereby incorporated by reference.

In one possible embodiment, the first, second, third, and fourth lower traces 120, 122, 128, 130 provide contact points for connecting the low voltage MEM switch 100 to a circuit or power source. These lower traces 120, 122, 128, 130 can have a variety of shapes and be connected to other electrically conductive wires and paths using conventional techniques such as solder, epoxies, and the like.

Although vias and traces mounted on the lower surface 106 of the substrate 102 are illustrated for connecting the MEM switch to other circuits, signal paths, and power supplies, it is understood that other structures for interconnection of the MEM switch can be used. For example, wire bonds or similar interconnects could be used to directly connect circuits, signal paths, and power supplies to the first and second bias ports 108 and 110 or the first and second contact traces 112 and 114.

Additionally, a ground plane 136 is mounted on the lower surface 106 of the substrate 102. The ground plane 136 is below and opposes the gap g₁ between the first and second contact ends 116 and 118 of the first and second contact traces 112 and 114, which are mounted on the upper surface 104 of the substrate 102. In one possible embodiment, the ground plane 136 is also beneath at least a portion of the first and second contact traces 112 and 114 to form the 50-Ohm microstrip lines.

In one possible embodiment, the substrate 102 is square or rectangular and has two dimensions, d₁ and d₂, which are perpendicular to one another and define the upper and lower surfaces 104 and 106. The lateral dimensions are those dimensions that are orthogonal to the depth dimension discussed below. The dimension d₁ is in the range of about 1 mm and about 5 mm. The dimension d₂ is in the range of about 1 mm and about 5 mm. Other embodiments might have different lengths for the dimensions d₁ and d₂. Additionally, the surface area for one side of the substrate 102 (e.g., upper or lower surface 104 or 106) is in the range of about 1 mm² and about 25 mm² although the surface area for other embodiment might be different sizes. Although the substrate 102 is illustrated as being square or rectangular, it could have a variety of other shapes. Examples of other shapes include circular and irregular shapes.

Referring back to FIGS. 1 and 2, a coil 138 is formed with a core 140 and a wire 142 wrapped around the core 140. The core has an upper end 144 and a lower end 146. The lower end 146 is mounted on the upper surface 104 of the substrate 102. The core 140 has an axis 143 substantially orthogonal to the upper surface 104 of the substrate 102 and is formed with a permeable material that is conducive to the flow of magnetic flux. An example of material that can be used to form the core 140 includes magnetic ferrite.

The core 140 can have a variety of different dimensions. In one possible embodiment, for example, the core 140 is cylindrical, has a diameter in the range of about 1 mm and about 3 mm and a length in the range of about 0.5 mm and about 3 mm. An alternative embodiment of the core 140 might include flanges (not shown) at the oppositely disposed ends, similar to a spool of thread, to help maintain the wire wraps in place.

The wire 142 is wrapped around the core 140 and has oppositely disposed ends 148 and 150. End 148 is soldered or otherwise bonded to the first bias port 108, and the oppositely disposed end 150 is soldered or otherwise bonded to the second bias port 110. The diameter of the wire 142 is in the range of about 1 μm and about 25 μm, although other sizes of wire are possible. The wire 142 is wrapped around the core 140 between about 100 turns and about 2000 turns, although the coil 138 may have more or less turns. One possible embodiment includes only a single layer of turns. Other embodiments have two or more layers of wire turns.

Many alternative embodiments of the coil 138 described herein are possible. For example, one possible embodiment has a printed coil in place of a wound coil.

A support member 152 has an upper end 162 and a lower end 160. The lower end 160 is mounted on the upper surface 104 of the substrate 102. The support member 152 and the coil 138 are positioned on opposing sides of the gap g₁ between the first and second contact traces 112 and 114. An arm 154 has first and second oppositely disposed ends 156 and 158, respectively. The first end 156 of the arm 154 is connected to the upper end 162 of the support member 152 and forms a cantilever. The arm 154 is formed with a material that is magnetically susceptible and thus is attracted to magnetic fields.

In one possible embodiment, the arm 154 has five segments 164a-164e extending between the first and second oppositely disposed end 156 and 158. The five segments 164a-164e are positioned end-to-end relative to one another. The first segment 164a extends from the first end 156 of the arm 154 and is in a substantially parallel to the upper surface 104 of the substrate 102 when the coil 138 is not energized. The second segment 164b extends from the first segment 164a in a downward direction toward the substrate 102. The third section 164c has a bottom surface 166, extends from the second segment 164b, and is substantially parallel to the upper surface 104 of the substrate 102 when the coil 138 is not energized. The fourth segment 164d extends from the third segment 164c in an upward direction away from the substrate 102.

The fifth segment 164e extends from the fourth segment 164d and terminates in the second end 158 of the arm 154. Two flanges or members 168 and 170 extend in opposite directions from oppositely disposed sides of the fifth segment 164e. The two flanges 168 and 170 are substantially perpendicular to the fifth segment 164e. When viewed from the top, as illustrated in FIG. 1, the flanges 168 and 170 give the arm 154 the appearance of a T-shape. The flanges 168 and 170 and the fifth segment 164e are substantially parallel to the upper surface 104 of the substrate 102. At least a portion of the fifth segment 164e and the flanges 168 and 170 are suspended above the upper end 144 of the core 140 when the coil 138 is not energized.

A contact bridge 172 is connected to the bottom surface 166 of the third segment 164c and is positioned so that it opposes the ground plane 136, although the substrate 102 is between the ground plane 136 and the contact bridge 172. Additionally, when the coil 138 is not energized, the contact bridge 172 is suspended over the first and second contact ends 116 and 118 of the first and second contact traces 112 and 114, and over the gap g₁ between the first and second contact ends 116 and 118.

The MEM switch 100 has an activated or closed state and a non-activated or opened state. The MEM switch 100 is in the non-activated state when the coil 138 is not energized and the fifth segment 164e of the arm 154 is suspended over the coil 138, and the contact bridge 172 is suspended over the first and second contact ends 116 and 118 of the first and second contact traces 112 and 114.

The MEM switch 100 is in the activated state when a voltage potential is applied across the first and second bias ports 108 and 110 and the coil 138 generates a magnetic field strong enough to move the fifth segment 164e of the arm 154 toward the upper end 144 of the core 140. When in the MEM switch 100 is in the activated state, furthermore, the contact bridge 172 lies against or is otherwise in electrical contact with the first and second contact ends 116 and 118 of the first and second contact traces 112 and 114. When the circuit is closed, the contact bridge 172 closes the circuit, and the contact bridge 172 and the first and second contact traces 112 and 114 form a signal path 174.

In one possible embodiment, a voltage potential of about 5 Volts or less and a current of about 10 mA or less actuates the MEM switch 100. In this embodiment, the coil 138 consumes about 50 mW or less of power. In another embodiment, a voltage potential of about 3 Volts or less and a current of about 10 mA or less actuates the MEM switch 100. In this embodiment, the coil 138 consumes about 30 mW Watts or less of power. In yet another possible embodiment, the coil 138 consumes power in the range of about 1 mW and about 50 mW when the MEM switch 100 is in the actuated state. In one possible embodiment, the impedance of the contact bridge 172 substantially matches the impedance of the first and second contact traces 112 and 114. One possible technique to match the impedance between the contact bridge 172 and the first and second contact traces 112 and 114 is to adjust the width of the contact bridge 172. In this embodiment, the electrical characteristics of the signal path 174 formed by the contact bridge 172 and the first and second contact traces 112 and 114 is expected to be substantially similar to the electrical characteristics of a single conductor. One possible impedance for the contact bridge is about 50 Ohms. Accordingly, it is anticipated that in one possible embodiment, the signal path 174 will conduct DC signals as well as a signal having at least one frequency component. In one possible embodiment, for example, the signal path 174 will conduct a signal having at least one frequency component of about 20 GHz or higher with a return loss of about 15 dB or higher. In another embodiment, it is anticipated that the signal path 174 will conduct a signal having at least one frequency component of about 30 GHz or higher with a return loss of about 15 dB or higher. In yet another possible embodiment, it is anticipated that the signal path 174 will conduct a signal having at least one frequency component of about 50 GHz or higher with a return loss of about 15 dB or higher.

In one possible embodiment, when the coil 138 is not energized, the gap g₂ between the upper end 144 of the core 140 and the fifth segment 164e of the arm 154 is about 12 μm or greater, and the gap g₃ between the upper surface 116 of the signal trace 112 and the lower surface 178 of the contact bridge 172 is between about 12 μm or greater. An advantage of this embodiment is that it is not required to hermetically seal the MEM switch 100 for many applications because the gap g₃ is large enough that some moisture on the first and second contact traces 112 and 114 and the contact bridge 172 will not necessarily close the circuit.

In another embodiment, the gap g₂ between the upper end 144 of the core 140 and the fifth segment 164e of the arm 154 is in the range of about 25 μm and about 1 mm, and the gap g₃ between the upper surface 116 of the signal trace 112 and the lower surface 178 of the contact bridge 172 is in the range of about 25 μm and about 1 mm. In yet another possible embodiment, the gap g₂ is in the range of about 12 μm and about 2 mm, and the gap g₃ is in the range of about 12 μm and about 2 mm. The gap g₂ is sized respect to the gap g₃ so that the upper end 144 of the core 140 will not stop movement of the actuator toward the substrate 116 before the contact bridge 172 closes the circuit between the first and second contact traces 112 and 114. Additionally, the distance between the first and second ends 156 and 158 of the arm 154 is in the range of about 1.5 mm and about 4 mm.

In one possible embodiment, a cover or lid 180 is connected to the substrate 102. The lid 180 and substrate 102 form a housing that encloses the coil 138, the arm 154, the contact bridge 172, the support member 152, the first and second bias ports 108 and 110, and the first and second contact traces 112 and 114. The lid 180 has a top portion 182, a first sidewall 184, a second sidewall 186, a third sidewall 188, and a fourth sidewall 190. The sidewalls 184, 186, 188, and 190 are connected to the substrate using conventional techniques. The overall depth d₃ of the enclosed MEM switch 100 assembly from the bottom 106 surface of the substrate 102 to the top portion 182 of the lid 180 is in the range of about 1000 μm and about 4000 μm. In one possible embodiment, the lid 180 is attached but not hermetically sealed to the substrate 102. In another possible embodiment, the lid 180 is hermetically sealed to the substrate 102.

The lid 180 can be made from a variety of materials, including materials that offer protection from environmental factors and material that is substantially non-permeable. An advantage of non-permeable materials is that it minimizes the effect of stray magnetic fields on the impedance of the contact bridge 172 and the contact traces 112 and 114. Other embodiments might use permeable materials to form the lid 180. An example of material that can be used to form the lid 180 includes Laminate RO4003 material. Another embodiment uses the same material as used to form the substrate 102.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

The claimed invention is:

1. A low-voltage micro electrical mechanical (MEM) switch, the low-voltage MEM switch comprising:
a contact bridge;
first and second microstrips, each microstrip having an impedance of about 50 Ohms, the first microstrip being electrically isolated from the second microstrip;
a cantilever arm supporting the contact bridge, the cantilever arm having an end portion, an open state, and a closed state, the contact bridge being spaced from the microstrip at a distance of about 12 μm or greater when the cantilever arm is in the open state and the contact bridge providing electrical communication between the first and second microstrips when the cantilever arm is in the closed state;
an electrically conductive coil opposing the first end, wherein the electrically conductive coil moves the cantilever arm from the open state to the closed state when a voltage of about 5 Volts or less are applied across the electrically conductive coil; and
a housing enclosing the cantilever arm, first and second microstrips, and electrically conductive coil, the housing having a height of about 4 mm or less, and the housing not being hermetically sealed.

2. A low-voltage micro electrical mechanical (MEM) switch, the low-voltage MEM switch comprising:
a cantilever arm having first and second end portions;
a contact bridge connected to the cantilever arm and positioned between the first and second end portions;
first and second microstrips, the first microstrip being electrically isolated from the second microstrip; and
an electrically conductive coil opposing the first end, wherein the electrically conductive coil moves the cantilever arm between an open state and a closed state, the contact bridge providing electrical communication between the first and second microstrips when in the closed state.

3. The low-voltage MEM switch of claim 2 wherein the distance between the contact bridge and the microstrip when the MEM switch is in an open state is about 12 μm or greater.

4. The low-voltage MEM switch of claim 3 wherein the distance between the contact bridge and the microstrip when the MEM switch is in an open state is in the range of about 12 μm and about 2 mm.

5. The low voltage MEM switch of claim 3 wherein the cantilever arm, contact bridge, microstrip, and electrically conductive coil are enclosed in a housing, and the housing is not hermetically sealed.

6. The low voltage MEM switch of claim 3 wherein the cantilever arm, microstrip, and electrically conductive coil are enclosed in a housing, the housing having a depth of about 4 mm or less.

7. The low-voltage MEM switch of claim 6 wherein the cantilever arm, microstrip, and electrically conductive coil are enclosed in a housing, the housing having a first lateral dimension of about 4 mm or less and a second lateral dimension of about 4 mm or less.

8. The low-voltage MEM switch of claim 6 wherein:
the housing includes a substrate and a cover; and
the cantilever arm, microstrip, and electrically conductive coil are mounted on a substrate and positioned underneath the cover.

9. The low-voltage MEM switch of claim 8 wherein the substrate is formed from a laminate and the microstrip is mounted directly on the substrate.

10. The low-voltage MEM switch of claim 2 wherein the coil is energized and moves the cantilever arm between the open and closed states when the coil is energized with a signal having a voltage of about 5 Volts or less.

11. The low-voltage MEM switch of claim 2 wherein the coil is energized and moves the cantilever arm between the open and closed states when the coil is energized with a signal having a current of about 10 mA or less.

12. The low-voltage MEM switch of claim 2 wherein the microstrip has an impedance of about 50 Ohms when the cantilever arm is in the closed state.

13. The low-voltage MEM switch of claim 2 wherein the contact bridge is formed from an electrically conductive material attached to the cantilever arm.

14. The low-voltage MEM switch of claim 2 wherein the cantilever arm is formed at least in part with an electrically conductive material, and the cantilever arm forms the contact bridge.

15. A low-voltage micro electrical mechanical (MEM) switch, the low-voltage MEM switch comprising:
a cantilever arm;
first and second microstrips, the first microstrip being electrically isolated from the second microstrip; and
means for moving the cantilever arm between a first position wherein the first and second microstrips and contact bridge form a closed circuit and a second position wherein the microstrips form an open circuit.

16. The low-voltage MEM switch of claim 15 wherein the means for moving the cantilever arm includes an electrical coil, the coil opposing the cantilever arm.

17. The low-voltage MEM switch of claim 16 wherein the coil is formed with wire that is 25 μm gauge or smaller.

18. The low-voltage MEM switch of claim 17 wherein the arm has first and second ends, the coil is positioned adjacent the first end, and the cantilever arm rotates around the second end.

19. A method of closing a circuit using a low-voltage micro electrical mechanical (MEM) switch, the method comprising:
providing a low voltage MEM, the low voltage MEM including a cantilever arm having first and second ends, a contact bridge connected to the cantilever arm and positioned between the first and second ends, an electrical path having first and second portions, and an electrical coil within a housing having a height less than about 4 mm;
applying a voltage of about 5 Volts or less across the electrical coil;
in response to applying the voltage of about 5 Volts or less across the electrical coil, pivoting the cantilever arm around the first end, thereby moving the contact bridge a distance in the range of about 12 μm and about 2 mm from a first position wherein the contact bridge forms an open circuit between the first and second portions of the electrical path to a second position wherein the contact bridge forms a closed circuit between the first and second portions of the electrical path; and
conducting an electrical signal along the first portion of the electrical path, through the contact bridge, and then along the second portion of the electrical path.

20. A method of closing a circuit using a low-voltage micro electrical mechanical (MEM) switch, the method comprising:
providing a low voltage MEM, the low voltage MEM including a cantilever arm, a contact bridge connected to the cantilever arm, an electrical path having first and second portions, and an electrical coil;
applying a voltage of about 5 Volts or less across the electrical coil; and
in response to applying the voltage of about 5 Volts or less across the electrical coil, moving the cantilever arm from a first position wherein the contact bridge is not in electrical contact with both the first and second portions of the electrical path to a second position wherein the contact bridge is in electrical contact with both the first and second portions of the electrical path.

21. The method of claim 20 wherein further comprising:
passing an electrical current of about 10 mA or less through the electrical coil simultaneously with the step of applying a voltage of about 5 Volts or less across the electrical coil.

22. The method of claim 20 wherein providing a low voltage MEM, the low voltage MEM including a cantilever arm, a contact bridge connected to the cantilever arm, an electrical path having first and second portions, and an electrical coil includes:
providing a low voltage MEM, the low voltage MEM including a cantilever arm, a contact bridge connected to the cantilever arm, an electrical path having first and second portions, and an electrical coil positioned within a housing having a depth of about 4 mm or less.

23. The method of claim 22 wherein providing a low voltage MEM, the low voltage MEM including a cantilever arm, a contact bridge connected to the cantilever arm, an electrical path having first and second portions, and an electrical coil includes:
providing a low voltage MEM, the low voltage MEM including a cantilever arm, a contact bridge connected to the cantilever arm, an electrical path having first and second portions, and an electrical coil positioned within a housing having a first lateral dimension of about 5 mm or less and a second lateral dimension of about 5 mm or less.

24. The method of claim 20 further comprising:
conducting an electrical signal along the first portion of the electrical path, through the contact bridge, and then along the second portion of the electrical path, the electrical signal having a frequency that is about 30 GHz or higher.

25. The method of claim 20 wherein moving the cantilever arm includes:
moving the contact bridge a distance of about 12 μm or greater.

26. The method of claim 25 wherein moving the contact bridge a distance of about 12 μm or greater includes:
moving the contact bridge a distance in the range of about 12 μm and about 2 mm.

27. The method of claim 26 wherein the cantilever arm has first and second ends, the first end being fixed in a stationary position, the second end being positioned proximal to the electrical coil, and the contact bridge being positioned between the first and second ends; further wherein moving the cantilever arm includes:
pivoting the cantilever arm around the first end until the contact bridge directly contact the first and second portions of the electrical path.
